(19) United States
(12) Patent Application Publication
(10) Pub. No.: US 2025/0347387 A1
(43) Pub. Date: Nov. 13, 2025

(54) SYSTEM OF EXPANDING THE STORAGE CAPABILITY FOR GEOMECHANICAL ENERGY STORAGE

(71) Applicant: Quidnet Energy, Inc., Houston, TX (US)

(72) Inventors: Bunker Hill, Sugar Land, TX (US); Henry Lau, Houston, TX (US); Scott Wright, Houston, TX (US); Dagong Zhou, Houston, TX (US)

(21) Appl. No.: 19/200,801

(22) Filed: May 7, 2025

Related U.S. Application Data
(60) Provisional application No. 63/644,542, filed on May 9, 2024.

(51) Int. Cl. F17C 1/00; B65G 5/00

(52) U.S. Cl. CPC F17C 1/007; B65G 5/00; F17C 2221/033; F17C 2227/0135; F17C 2265/06; F17C 2270/0581

(57) ABSTRACT

An expanded system and method for storing energy underground as high-pressure fluid in one or more subterranean zones and utilizing one or more wells. The wells may be connected to some or all of the subterranean zones which may be naturally occurring volumes in the rock structure, hydraulically fractured volumes in the rock structure, or hydraulically fractured an sealed volumes in the rock structure.

### CROSS-REFERENCE TO RELATED APPLICATION

This application claims the benefit of U.S. Provisional Patent Application No. 63/644,542, filed May 9, 2024, which is hereby incorporated by reference in their entirety herein.

### BACKGROUND OF THE INVENTION

### I. Field of the Invention.

The present disclosure relates generally to an energy storage system with one or more: subterranean zones, wells, ponds, and sub-systems in which to store a working fluid until the energy is needed at the surface to perform useful work, and more particularly to expanding the storage capabilities thereof.

### II. Description of the Prior Art.

While it is relatively easy for electrical power to move from place to place over long distances, electrical power demand is ever increasing in the United States as it is used, among other things, for lighting, heating, cooling, refrigeration, electronics, machinery, and some transportation systems. Moreover, the frequency of peak power events is increasing as the number of power-hungry devices attached to the North American power transmission grid increases. In the United States, much of the electricity is generated by burning natural gas as a fuel.

Energy storage is needed to balance the large variations in supply and demand to supplement the power generation systems currently in use. High summer temperatures, low winter temperatures, electric powered transportation methods, artificial intelligence (AI) data methods and the like are adding to the power needs of today. Large scale energy storage methods currently include compressed air energy storage (CAES), natural gas cavern storage, pumped hydro, chemical batteries, and subterranean energy storage. Each energy storage system uses different physics and mechanics to achieve the goal of providing energy when it is needed in sufficient quantity. Underground, cavern, and natural gas storage is popular in Europe and other places around the world to store chemical energy until it is needed in the long heating season.

CAES relies on the elasticity of the working fluid and the thermal expansion of the working fluid at the surface to produce useful work. Accordingly, for hydraulic systems like CAES, PE (potential energy)=(½) kx², where: PE is the elastic potential energy (measured in joules, J) k is the spring constant (measured in newtons per meter, N/m) and x is the displacement from the equilibrium position (measured in meters, m).

Pumped hydro is the method of storing energy by pumping water to a higher elevation, storing it, then later allowing the water to fall under gravitational forces to spin a turbine/generator combination to produce electricity. Water is pumped up the hill during off-peak demand periods when electricity is available at a lower cost. For pumped hydro, (potential energy)=mass of water (m)×gravitational acceleration (g)×height difference (h).

Subterranean energy storage is similar to compressed air energy storage (CAES) in that the working fluid is stored underground, however the energy recovery mechanisms are quite different. Both systems can gain some geothermal energy from the earth to warm the working fluid. The subterranean energy storage relies on the elasticity of the earth and the overburden on the rock where the working fluid is stored and the thermal energy gathered by the working fluid.

In the construction phase of the subterranean energy storage system the well, the subterranean zone, and the surface facilities must be built and/or properly prepared for the operation phase. A subterranean zone can be made up of man-made hydraulic fractures, natural fractures, natural occurring caves, or other fluidically connected geologic features. Not all subterranean systems include fractured formations in the subterranean zone. Some are well sealed and do not require hydraulic fracturing or sealing.

For this technology any or all fluidically connected parts can be used to store high pressure fluid. The fluid stored may be used as the working fluid for a system to produce electricity or other useful work below ground or above ground.

The steps to prepare the zone, fracture, store high pressure fluid in the subterranean zone, and then move it to the surface equipment to perform useful work, desalinate water and generate electricity are described in applicant's earlier granted patents, U.S. Pat. Nos. 8,763,387, 9,481,519, 10,669,471 10,125,035, 11,125,065, 11,927,085, 11,326,435, 12,264,569, 12,276,443, 12,173,227, 12,264,566, and 12,123,293 all of which are hereby incorporated by reference in their entirety herein. Also hereby incorporated in their entirety herein are applicants' U.S. Pat. No. 11,795,802 describing the creation of fractures in the subterranean zone, sealing it, and preparing it to store high-pressure working fluids which are later moved to the surface to perform useful work; and U.S. Pat. No. 12,123,293 describing other methods to fracture and seal the subterranean zone prior to utilizing it for storage of the high-pressure working fluid.

Essentially, the first step is to collect and evaluate geologic data. Pilot wells may be drilled to collect various geologic data including core samples to verify models. Once a feasible well placement has been determined, one or more wells are drilled, then one or more casing strings are run and cemented in place. Completions are designed and placed in a manner that allows the working fluid to traverse between the wellbore and subterranean formation with the least restriction. In some instances, it may be necessary to sever the upper casing from the lower casing. There are many methods available today to perform this operation which may include techniques such as perforating, fracturing, water jetting, or others to establish a smooth fluid flow path into and out of the subterranean zone for the working fluid through the wellbore.

After the well is constructed, pressure pumping and fluid mixing equipment are moved to the location. One or more treatment schedules are injected into the target subterranean formation to artificially modify the permeability of the formation. At this time the formation can be sealed and prepared for the operation phase.

During the operation phase, a working fluid is injected down the well bore, and out into the fracture, or fracture network, of the subterranean zone. Energy is stored in the subterranean zone as high-pressure fluid. Fluid is pumped from a low-pressure storage area to a high-pressure subterranean zone where it can be used immediately or stored for a period of time before being moved to the surface to produce useful work. The high-pressure fluid can, for example, be used with a turbine/generator set to produce electricity. Low-pressure storage can be a subterranean zone located close to the surface.

One or more wells might be used in the subterranean energy storage system. Some may be dedicated to injection or production flow, or a combination of these regimes depending on subterranean zone access and system demands. In any event, the fluid is stored there under pressure until all, or part of the fluid volume is returned to the surface. In most instances, this high-pressure fluid will be used to produce electricity. The output could be used to power a data center, an industrial plant, a manufacturing center, a food processing plant or some other medium to large scale facility needing energy.

Once such subterranean energy storage facilities are constructed and operational, the stored energy can be released to produce usable work, such as electricity. In order to convert this stored energy as efficiently as possible, a control system needs to be utilized.

If the fracture is tough enough and does not leak too much, it may be acceptable to cycle the working fluid into and out of the subterranean zone without placing any sealing material in it.

It is important to note that the well bore can be vertical, near vertical, horizontal, near horizontal or at any angle. Likewise, the fracture opening or the subterranean zone, or the storage fractures can be vertical, near vertical, horizontal, near horizontal or at any angle relative to the well bore.

Historically, many different materials and techniques have been used in oil and gas wells to stop the flow of water from an underground zone into the well bore. It is important to control the flow of unwanted formation water from entering the well bore in large amounts as the water reduces hydrocarbon flow, increases corrosion, and decreases the life and profitability of the well. This technology goes back nearly 100 years and many different fluid systems are currently available. Such systems have been used in oil and gas wells for different phases of drilling, completion, and production engineering for lost circulation control, drilling fluids, plugging agents, fracturing fluids, water shut off, and water profile control.

Having more than one zone in fluid communication with one or more well bore makes the system larger and more easily adapted for optimization of sub systems. For example, a large high-pressure zone could be used to fill a lower pressure zone attached to the same well bore or another well bore to optimize the use of the second well bore's surface facilities. If one system or sub system is down for maintenance, fluids could be moved to optimize a field of systems. Accordingly, it is a general object of the present disclosure to expand the storage capability of an energy storage system.

It is another general object of the present disclosure to provide a system and method to expand the capabilities to store energy underground as a high-pressure working fluid.

It is another general object of the present disclosure to provide a system and method to enlarge the zones to store fluids underground in any type of geologic structure or rock type.

It is yet another general object of the present disclosure to provide a system and method to adapt one or more zones for fluid communication with one or more well bores to optimize subsystems.

These and other objects, features and advantages of this disclosure will be clearly understood through consideration of the following detailed description.

### SUMMARY OF THE INVENTION

According to an embodiment of the present disclosure, there is provided a system for optimizing high-pressure fluid in a subterranean zone including a working fluid storage mechanism supplying the fluid to the system through a facility that pumps and retains same. Three or more subsystems are in fluid communication with each other wherein at least one subsystem is a subterranean zone and at least one subsystem is a wellbore. A fluid control device controls the fluid and optimizes the systems parameters.

### BRIEF DESCRIPTION OF THE DRAWINGS

The present disclosure will be more fully understood by reference to the following detailed description of one or more preferred embodiments when read in conjunction with the accompanying drawings, in which reference characters refer to like parts throughout the views and in which:

FIG. 1 is a simplified schematic view of a subterranean fluid storage system according to the principles of an embodiment of the present disclosure

FIG. 2 is a simplified schematic view of a first well intersecting the side of the subterranean zone.

FIG. 3 is a simplified schematic view of a fluid storage with two wells both in fluid communication with a single subterranean zone.

FIG. 4 is a simplified schematic view with several wells some of which are in fluid communication with some of the subterranean zones.

FIG. 5 is a simplified schematic view of a single well in fluid communication with two subterranean zones.

FIG. 6 is a simplified schematic view of a single well in fluid communication with two subterranean zones which are fluidically connected.

### DESCRIPTION OF THE PREFERRED EMBODIMENTS

One or more embodiments of the subject disclosure will now be described with the aid of numerous drawings. Unless otherwise indicated, use of specific terms will be understood to include multiple versions and forms thereof.

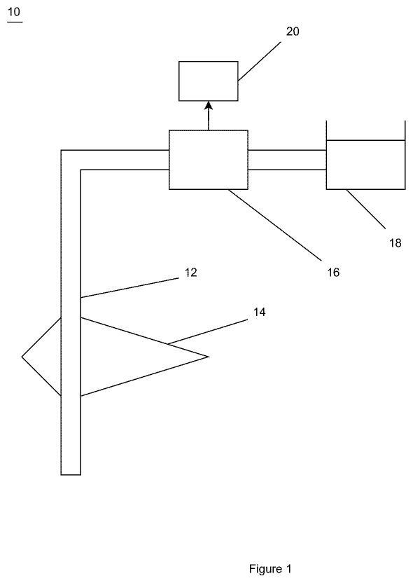

FIG. 1 illustrates an embodiment of a method and system 10 for storing fluid underground for the purpose of energy storage. The energy storage is assisted by the overburden of the earth, the elasticity of the rock, and in some instances the compressibility of the working fluid. As shown, a well 12 with a subterranean zone 14 is connected to a surface facility 16 which is connected to a fluid storage mechanism 18. The surface facility 16 may contain pumps, turbines, generators, and equipment necessary to convert the energy stored as high-pressure fluid to usable work. The low-pressure working fluid is shown as an open top tank 18. A surface pond or a low-pressure subterranean zone might be used, combined, or added depending on the system requirements and operating characteristics. The usable work output 20 is shown above the surface facility 16.

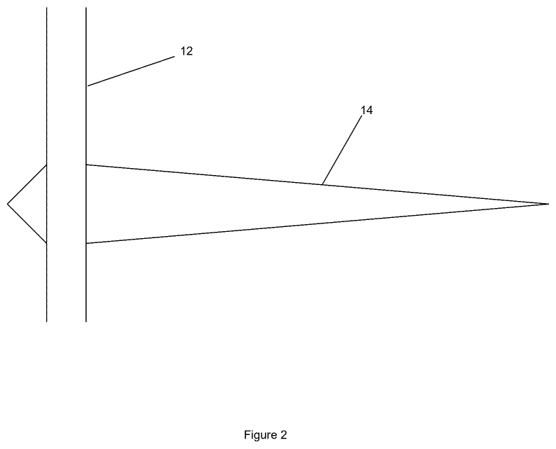

FIG. 2 illustrates an embodiment of a method and system 10 for storing fluid underground for the purpose of energy storage. As shown, a well 12 is in fluid communication with a subterranean zone 14.

The optimization of a field full of small, medium, or large size subterranean energy storage systems 10 that each have at least one of the subsystems including but not limited to a subterranean storage zone, a wellbore, a surface storage, surface equipment with a pump, turbine, and generator system is realized from the utilization of the subject disclosure. These subsystems could be optimized by (i) having one or more zones in fluid communication with the well bore, (ii) having one or more wellbores in communication with a subterranean zone, (iii) having one more zones in fluid communication with other zones and/or (iv) a hybrid of any (i), (ii), or (iii).

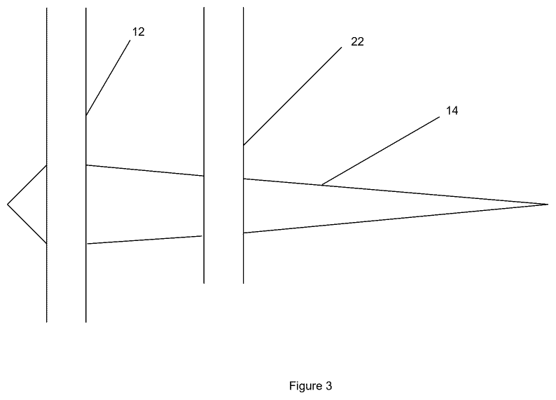

FIG. 3 depicts two wells 12 and 22 connected to a subterranean zone 14. This configuration might be used in alternative configurations of the sub-systems when a large volumetric flow rate is needed from the subterranean zone 14. In another embodiment two or more wells might be used with a single subterranean zone 14 where one well 12 is optimally placed for fluid injection while the second well 22 is optimally placed to convey fluid from the subterranean zone 14 to the surface equipment. In this configuration the fluid friction may be reduced, thus increasing the overall system efficiency.

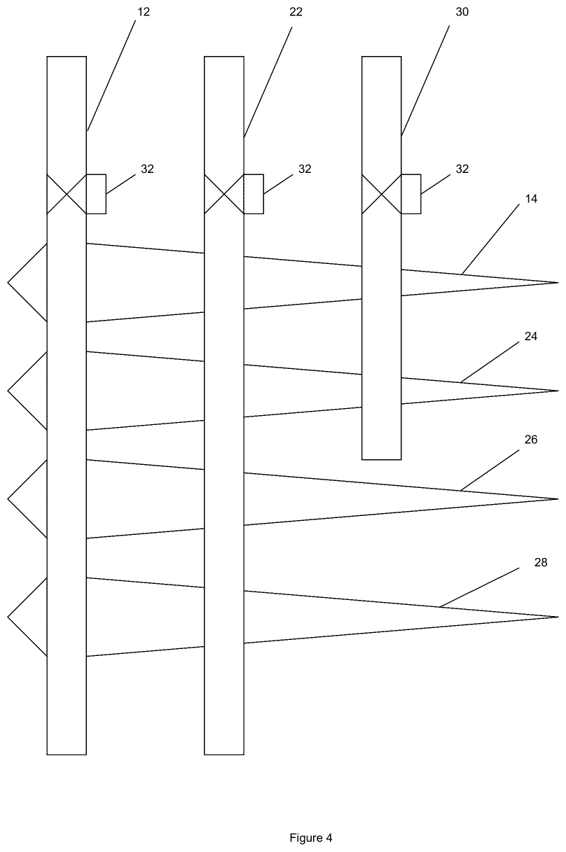

As shown in FIG. 4, multiple subterranean zones 14, 24, 26, 28 could be used to increase the volume, flow rate and duration of the high-pressure fluid flow to the surface through multiple wells 12, 22, 30. Subterranean zones might be used for high-pressure and/or lower pressure fluid storage. This may be useful if the surface area is minimized and a holding pond or tank cannot be accommodated.

If a small or medium size surface pond is low on working fluid it could be replenished from another system's subterranean zone. Additionally, instead of using a pond, a system could flow from one high pressure zone to a lower pressure zone utilizing the same or different wellbore(s).

If one system's surface facilities are down for maintenance, the flow might be diverted from it's subterranean storage and well bore to that of another system's in order to meet local or national electrical grid demands.

One way to control flow between subterranean zones is to install fluid control devices in the well completion. Sliding sleeve valves, fixed chokes variable chokes, pressure transducers, flow meters, temperature transducers, or other subsurface flow control devices 32 could all be used to physically control fluid flow. Similarly, surface equipment, internal or external the facility 16, with or without downhole flow control, could be utilized to control flow from one zone to another zone if each zone was hydraulically connected at the surface. Also, the data could be captured and fed to a mathematical model to assist a software package in optimizing the field or network of systems. Reductions or predictions in downtime, high financial performance, steady electrical production and other aspects might be optimized with large scale and control of subsystems.

Limited entry perforating can be used to regulate fluid flow distribution across the length of the completed interval(s). Multiple wellbores can be beneficial if certain geology requires a dedicated injector well and producer well rather than a bi-directional single wellbore. Also, some geologies, wells, and completion equipment might be optimized by fracturing from one well and producing from one or more additional wells that are fluidly coupled to the same fracture or subterranean zone.

If seal maintenance and/or remediation is required, such as if re-application of a sealant treatment is required in a given zone, then the wellbores can be configured in a manner to create effective zonal isolation so that targeted re-seal treatments can be applied. The adjacent wellbores or zones may continue operations while seal maintenance is being performed on a particular zone/interval. Alternatively, adjacent wellbore or zones may be used to assist with more efficient placement of the re-seal treatment. In one embodiment, the adjacent wellbores or zones may be used to monitor the subterranean formation for responses in pressure, strain, and/or flow, to infer placement progress and status. In another embodiment, multiple adjacent wellbores can be used simultaneously as a conduit to place the re-sealant treatment.

Various re-sealant treatment fluids may be used during seal maintenance and/or remediation. In one embodiment, fluids are used to dissolve the original sealant in-situ. In another embodiment, fluids are used to place, establish or reinforce a stronger and more competent seal to restore the energy storage capabilities of the subterranean zone. In another embodiment, fluids are used to displace other fluids for the purpose of deliberate and controlled fluids placement in-situ.

Turning back to FIG. 1, a well 12 with a subterranean zone 14 is connected to a surface facility 16 which is connected to a low-pressure fluid storage mechanism 18. The surface facility 16 will contain at least one pump and one turbine/generator set for converting high-pressure fluid to electricity. The usable work output 20 is shown above the surface facility 16. It is important to note that the well bore can be vertical, near vertical, horizontal, near horizontal or at any angle. Likewise, the fracture opening, or the subterranean zone can be vertical, near vertical, horizontal, near horizontal or at any angle relative to the well bore. Also the well can be located an end of the fluid volume contained in the subterranean zone, or it may be located near the center.

Each subterranean zone can be made up of rock formations that are naturally sealed well enough to contain the high-pressure working fluid with high stress boundary layers or it may be hydraulically fractured and be sealed well enough to contain the high-pressure working fluid. In some instances, the formation rock will be hydraulically fractured and sealing material will be placed in the fracture tips and/or rock pores to contain the high-pressure working fluid.

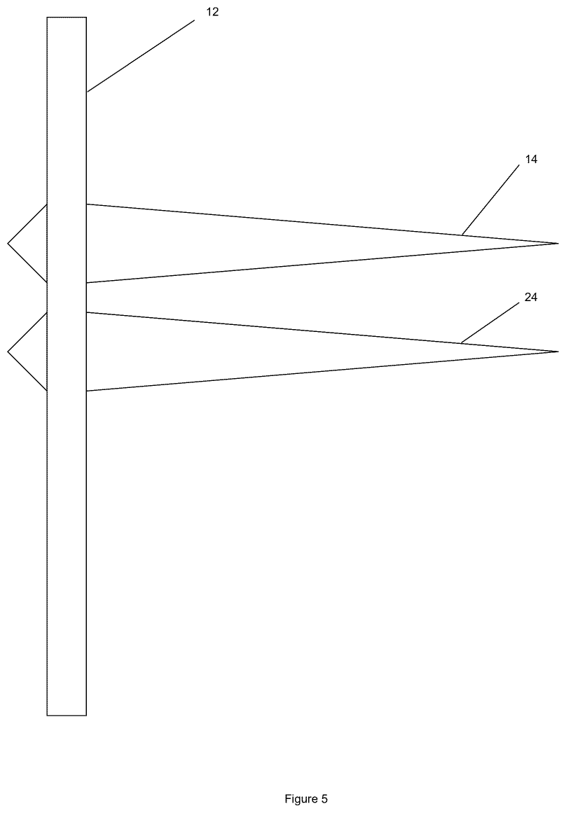

FIG. 5 depicts a well 12 fluidically connected to two subterranean zones 14 and 24. Two or more subterranean zones could be utilized in this configuration to increase the energy capacity stored. Configurations with large volumes of high-pressure fluid may be used to produce usable work or generate electricity for extended periods of time as the volumetric flow rate might be sustained for a longer period of time than a system with a smaller volume of high-pressure working fluid. This configuration of one well bore 12, connected to one or more subterranean zones might be used in combination with different types of rock formations. Some may need to be fractured and sealed while others might be utilized with little or no modification. One measure of the rock formation's integrity will be the leak rate of the working fluid while stored under high-pressure.

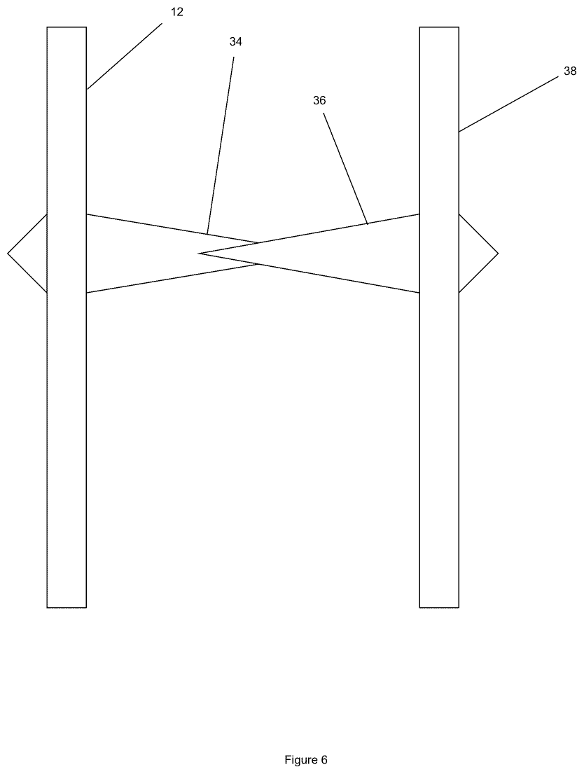

FIG. 6 depicts one well 12 connected to a subterranean zone 34, which is fluidically connected to subterranean zone 36 and well 38. This configuration may be used to optimize injection rates and pressures, fluid storage volume, production flow rates and pressures, idle pressure, storage duration, or other parameters. The subterranean zones might be naturally connected, or man-made connections might be established through hydraulic fracturing techniques similar to those used in oil and gas wells and geothermal, hot rock, underground energy gathering facilities.

A large amount of energy may be used to pump the fluid into one or more subterranean zones. This is the injection pressure. Idle pressure is the pressure of the subterranean zone when energy is stored and not flowing into or out of the system. Such pressure may be converted to mechanical work when the fluid returns to the surface. This is the production pressure. Some of such pressure may be used to produce electricity. For instance, the pressure may be used to generate electricity by turning a shaft on a generator.

Monitoring of the well, surface facilities, and the subterranean zones can be done with conventional data acquisition equipment which might include, but is not limited to tiltmeters, InSAR, pressure and temperature gauges and transducers, flow meters, floats, distance measurement devices, downhole temperature, pressure flow rate, fiber optic means, seismic, etc. Modern control techniques including SCADA, software, reporting, dashboards, communications, security, etc. might be utilized for surface and subsurface.

A large capacity energy storage facility may contain more than one well connected to one or more subterranean zones to store high-pressure working fluid until it is needed to produce work. Each of the one or more wells could either be used to inject or produce fluid. In some instances, a well completion, flow area, or installed equipment might be optimized for fluid injection while another well connected to the same subterranean zone might be optimized for flow from the subterranean zone to the surface equipment. Multiple wellbores spaced apart and connected to a single zone may each act independently to inject and produce energy from the zone of interest.

In other embodiments, a single well can be fluidically connected to one or more subterranean zones in order to expand the energy storage capability of the system. Well/subterranean zone combinations can be combined together to fill a field of energy storage system in order to maximize efficiency and energy storage capacity. Storing energy and returning energy in multiple zones connected to the same wellbore may be injecting from the surface into multiple target zones on the same wellbore, storing the energy, then producing the water up the wellbore from the same multiple zones.

Alternative embodiments include subterranean zones composed of fractured rock formations that may or may not require sealing materials to limit the loss of the high-pressure working fluid. One well may be in fluidic communication with one or more subterranean zones enhanced via fracturing techniques. The zones might be spaced close to a vertical, or near vertical well bore. In other instances, the well might be a horizontal, or near horizontal and the center of the subterranean zone may or may not be close to the well.

In some configurations two wells and two subterranean zones may be utilized. By way of example, a first well can be fluidically connected to a high-pressure, fractured and sealed subterranean zone while a second well with a second fracture and sealed subterranean zone. Each well could be connected to one or more surface facilities and the working fluid could be moved back and forth between the two sub systems each of which is composed of at least one well and at least one subterranean zone. By way of further example, the first wellbore, with a high-pressure created and sealed fracture on that wellbore, and a second wellbore with a low-pressure sealed fracture on that wellbore so that the facility can pump between the low and the high-pressure wellbores. Further example still, a single wellbore with multiple fractures created and sealed at various locations along the wellbore, and the fluid is injected from the single wellbore into the multiple zones, stored, then produced from the multiple zones on the same wellbore.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention in its broader aspects, and, therefore, the aim in the appended claims is to cover all such changes and modifications as fall within the true spirit and scope of the present disclosure.

What is claimed is:

1. A system for optimizing high-pressure fluid in a subterranean zone, the system comprising:
a working fluid storage mechanism to supply the fluid to the system;
a facility to pump and retain the fluid from said storage mechanism to said system;
three or more geomechanical subsystems in fluid communication with each other;
at least one of said subsystems being a subterranean zone adapted to receive and retain the fluid;
at least one of said subsystems being a wellbore; and
a fluid control device to control the fluid and optimize a system parameter.

2. The system as defined in claim 1 wherein said device is within said facility.

3. The system as defined in claim 1 wherein said device is within one of said subsystems.

4. The system as defined in claim 1 wherein said storage mechanism is above a surface.

5. The system as defined in claim 1 wherein said storage mechanism is one of said subsystems.

6. The system as defined in claim 1 wherein said parameter is a fluid storage volume.

7. The system as defined in claim 1 wherein said parameter is a fluid storage duration.

8. The system as defined in claim 1 wherein said parameter is an injection rate.

9. The system as defined in claim 1 wherein said parameter is a production rate.

10. The system as defined in claim 1 whereon said parameter is an injection pressure.

11. The system as defined in claim 1 wherein said parameter is a production pressure.

12. The system as defined in claim 1 wherein said parameter is an idle pressure.
